(19) United States
(12) Patent Application Publication
(10) Pub. No.: US 2010/0187217 A1
(43) Pub. Date: Jul. 29, 2010

(54) COOKING DEVICE

(76) Inventors: Keiko Isoda, Hyogo (JP); Hideaki Kobayashi, Hyogo (JP); Yoshiaki Ishio, Hyogo (JP); Hidekazu Suzuki, Hyogo (JP); Taihei Oguri, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/669,614

(22) PCT Filed: Jul. 18, 2008
(86) PCT No.: PCT/JP2008/001926

§ 371 Date: Jan. 19, 2010

(30) Foreign Application Priority Data
Jul. 19, 2007 (JP) 2007-187914

(51) Int. Cl. H05B 3/68; H05B 3/02

(52) U.S. Cl. 219/450.1; 219/482

(57) ABSTRACT

There is provided a cooking device including a plurality of switches that is easy to use for users requiring only part of the functions of the cooking device. A cooking device includes a control mode switch (6a, 6c, 6d, 6g) for selecting a control mode for controlling a heating operation; a setting switch (6b, 6e, 6f) for selecting a set value in each control mode; a heating control unit (10) for controlling a heating unit (3) based on the control mode and the set value inputted through the control mode switch and the setting switch; and a selection switch (8a) for selecting the operation mode; wherein the operation modes include a first operation mode in which all of the plurality of control modes are set to be selectable and a second operation mode in which only part of the control modes are set to be selectable; and the heating control unit sets only the control mode switch and the setting switch necessary for the control modes which are set to be selectable in the operation mode selected by the selection switch to be enabled.

### TECHNICAL FIELD

The present invention relates to a cooking device for heating a cooking container. In particular, the present invention relates to a cooking device including a plurality of operation switches to control cooking.

### BACKGROUND ART

There is provided a cooking device which has an operation unit provided on a front surface of a main body serving as shell, and a cooking device which has an operation unit provided on a top plate for placing the cooking container. Moreover, there is provided a cooking device which has the operation units provided on both the top plate and the front surface of the main body (see e.g. Patent document 1). The operation unit is made up of a plurality of switches, each of which is assigned with a predetermined function.

Patent document 1: JP-A72003-208972

### DISCLOSURE OF INVENTION

### Problems to be Solved by the Invention

The number of functions provided in the cooking device is increasing in recent years. For example, functions such as a timer function for setting cooking time and an automatic cooking function for automatically performing water boiling, rice cooking, and the like are newly provided to the cooking device. Each of such functions is assigned to the switch, and thus the number of switches increases as the number of functions increases. The operation becomes complicating if the number of switches is increased with an increase in the number of functions of the device, and a target operation becomes difficult to perform for a user who does not require all the functions. Thus, there arises a problem in that an operating error of the user increases. Such a problem is especially serious to the user who does not require many functions or who cannot make sufficient use of the functions.

In view of solving the problems of the related art, it is an object of the present invention to provide a cooking device including a plurality of switches that is easy to use for users who require only part of the functions of the cooking device.

### Means for Solving the Problems

A cooking device according to the present invention includes: a main body serving as shell; a top plate provided on an upper surface of the main body; a heating unit operable to heat an object to be heated placed on the upper surface of the main body; at least one control mode switch operable to select one of a plurality of control modes for controlling a heating operation of the heating unit; at least one setting switch operable to select a set value in each control mode; a heating control unit operable to control the heating unit based on the control mode and the set value inputted through the control mode switch and the setting switch; and a selection switch operable to select one operation mode from a plurality of operation modes; wherein the operation modes include a first operation mode in which all of the plurality of control modes are set to be selectable and a second operation mode in which only part of the plurality of control modes are set to be selectable; and the heating control unit sets only the control mode switch and the setting switch necessary for the control modes which are set to be selectable in the operation mode selected by the selection switch to be enabled. With this configuration, there is provided a cooking device that can respond with a simple switching to both a user who can perform complicating operations and attempts to use a great number of functions, and a user who uses only simple functions and desires easy operation.

The cooking device may further include a first notifying unit operable to notify distinctively the enabled control mode switch and the enabled setting switch from the disabled control mode switch and the disabled setting switch in the second operation mode. The user can thus know which switch is operable. For example, the switch itself may be illuminated or non-illuminated to notify the enabled control mode switch and the enabled setting switch, and the disabled control mode switch and the disabled setting switch in a distinguished manner.

The enabled control mode switch and the enabled setting switch may be arranged adjacent to at least one other enabled control mode switch or enabled setting switch in the second operation mode. The user can thus easily determine the usable control mode switch and the usable setting switch, and the unusable control mode switch and the unusable setting switch.

The cooking device may further include a second notifying unit operable to notify whether the cooking device is operating in the first operation mode or in the second operation mode; wherein when the disabled control mode switch or setting switch is operated, at least one of the first notifying unit or the second notifying unit may notify that the operated control mode switch or the operated setting switch is disabled. With this configuration, when the user mistakenly operates the unusable control mode switch or the unusable setting switch, the user can be notified of the mistake.

An operation of the selection switch may be hard to be accepted compared to operations of the control mode switch and the setting switch. The operation mode is thus not easily changed even when the user touches the selection switch by mistake while operating another switch.

The selection switch may be a switch which has an electrical contact and is operable to open or close; and the control mode switch and the setting switch may be touch switches of electrostatic capacity type. The operation mode is thus not easily changed even when the user touches the selection switch by mistake while operating another switch.

The cooking device may further include: a power switch operable to disable all operations in an OFF state of the power switch and to enable at least one switch to be operated in an ON state of the power. switch; and a non-volatile memory operable to store the operation mode selected by the selection switch when the power switch is in the ON state; wherein the cooking device may be operate in the stored operation mode when the power switch is turned from off to on. With this configuration, the operation mode can be stored even after the main power of the device is turned off, and the device can be started up at the previously set operation mode when the main power is turned on the next time.

### Effects of the Invention

According to the present invention, the user can select the first operation mode in which all control modes can be used and a second operation mode in which only part of the control modes can be used since a selection switch for switching the operation modes is arranged. Thus, with one cooking device, all controls modes can be provided in the first operation mode to the user who desires to use all the functions, and only part of the control modes can be provided in the second operation mode to the user who only uses some functions. Therefore, even with the cooking device including a plurality of switches, the types of selectable control modes and the number of usable switches can be reduced with the switching operation of the selection switch for the user who requires only some functions. Thus, an operating error by the user who does not require a great number of functions or who cannot make sufficient use of the functions can be prevented, and convenience is enhanced even to such users.

### BRIEF DESCRIPTION OF DRAWINGS

FIG. 1 is an overall configuration diagram of a cooking device according to first and second embodiments of the present invention.

FIG. 2 is a view showing a top surface operation unit and a top surface display unit in the first and second embodiments of the present invention.

FIG. 3 is a view showing a front surface Operation unit and a front surface display unit in the first and second embodiments of the present invention.

FIG. 4 is a block diagram showing the cooking device of the first embodiment of the present invention.

FIGS. 5A and 5B are views showing a display example of a full mode after power is turned on in the first and second embodiments of the present invention.

FIGS. 6A and 6B are views showing a display example during heating in the full mode in the first and second embodiments of the present invention.

FIGS. 7A and 7B are views showing a display example of a simple mode after the power is turned on in the first and second embodiments of the present invention.

FIGS. 8A and 8B are views showing a display example during heating in a simple mode in the first and second embodiments of the present invention.

FIG. 9 is a block diagram showing the cooking device of the second embodiment of the present invention.

FIGS. 10A and 10B are views showing another display example of a simple mode after the power is turned on in the first and second embodiments of the present invention.

### DESCRIPTION OF REFERENCE NUMERALS

1 main body

2 top plate (top panel)

3 heating unit

4 cooking container (object to be heated)

6 top surface operation unit

6a unlock switch (control mode switch)

6b timer switch (setting switch, control mode switch)

6c automatic switch (control mode switch)

6d fried-food ON/OFF switch (control mode switch)

6e down switch (setting switch)

6f up switch (setting switch)

6g heating ON/OFF switch (control mode switch)

7 top surface display unit

8 front surface operation unit

8a selection switch

9 front surface display unit

10 heating control unit

15 power switch

### BEST MODE FOR CARRYING OUT THE INVENTION

Embodiments of the present invention will be described below with reference to the drawings. It should be noted that the present invention is not limited to the embodiments.

### First Embodiment

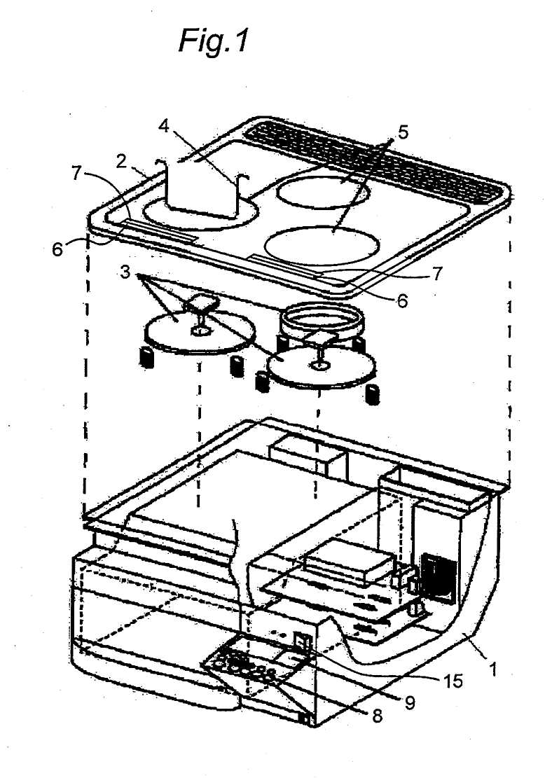

FIG. 1 shows a configuration of a cooking device according to a first embodiment of the present invention. In the cooking device of FIG. 1, a top plate 2 made of crystallized ceramic, which is a top panel, is provided on the upper surface of a main body 1 serving as shell. Below the top plate 2 of the main body 1, there is arranged a heating unit 3 for heating a cooking container 4, which is an object to be heated, placed on the top plate 2. In FIG. 1, three heating units 3 are arranged. Such heating units 3 are respectively configured by an induction heating coil for heating the cooking container 4 by induction heating, or a radiant heater for heating a pan that is not suited for induction heating. A heating display unit 5 for indicating a user a location to place the cooking container 4 is provided at a position facing the heating unit 3 on the surface of the top plate 2. For example, in a case of a gas cooker, a through-hole may be formed in the top plate 2 forming the upper surface of the device, and a gas burner may be provided at the portion of the through-hole as the heating unit. In such a case, the object to be heated is placed on the gas burner that forms the upper surface of the main body.

A top surface operation unit 6 including switches assigned with commands such as start and stop of heating of the heating unit 3 is arranged in a substantial same plane as the top plate 2. A top surface display unit 7 for displaying various states according to the operation of the top surface operation unit 6 is arranged on the top plate 2. The top surface display unit 7 is a notifying unit for notifying various states to the user by a liquid crystal, an LED, and the like. For example, when a switch that is set to be unusable is operated, the top surface display unit 7 notifies the user that the switch cannot be operated by flashing the LED, and the like.

A front surface operation unit 8 of open/close storage type and a front surface display unit 9 for displaying various states according to the operation of the front surface operation unit 8 are provided on the front surface of the main body 1. The front surface display unit 9 is a notifying unit for notifying the user of various states by a liquid crystal, an LED, and the like.

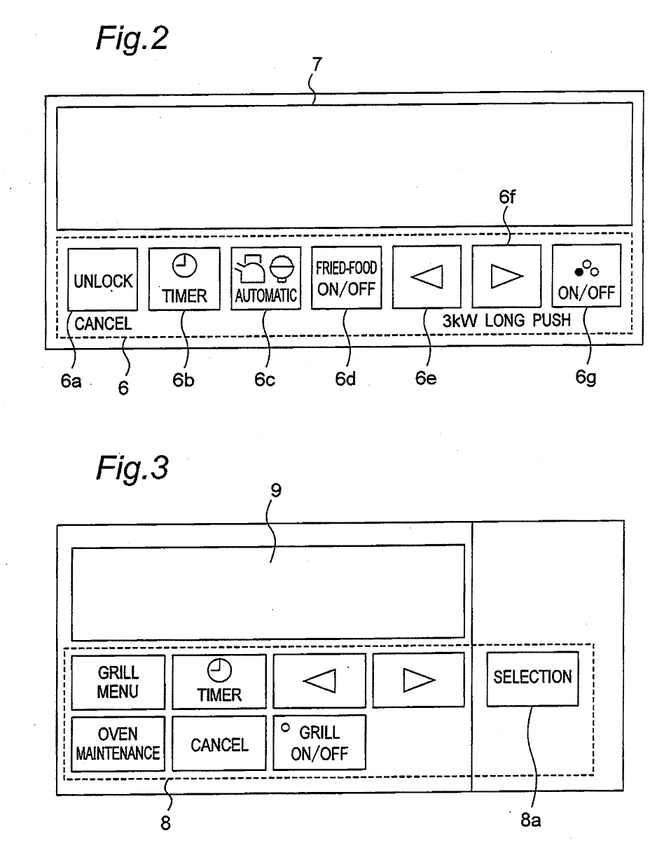

FIG. 2 shows the top surface operation unit 6 and the top surface display unit 7 arranged on the top plate 2. The top surface operation unit 6 forms a touch switch of electrostatic capacity type for performing switch operation when the surface of the top plate 2 is touched in the case of arranging an electrode at the back surface of the top plate 2 and applying a high frequency voltage to the relevant electrode. The top surface operation unit 6 includes an unlock switch 6a assigned with a function of changing a control mode of the cooking device to a control mode in which the switch operations of the switches 6b to 6g of the top surface operation unit 6 can be performed; a timer switch 6b for transitioning to a timer mode as well as for setting a cooking time (set value) in a heating mode; an automatic switch 6c assigned with a function for selecting a control mode of automatically performing water boiling and rice cooking; a fried-food ON/OFF switch 6d used when selecting a fried-food cooking mode; a down switch 6e for lowering heating power and a temperature (set value); an up switch 6f for raising the heating power and the temperature (set value); and a heating ON/OFF switch 6g for changing from a stop mode to the heating mode and changing from the heating mode to the stop mode.

The cooking device of the present embodiment has control modes including an unlock mode, the timer mode, an automatic cooking mode, a fried-food mode, and the heating mode, where the unlock switch 6a, the automatic switch 6c, the fried-food ON/OFF switch 6d, and the heating ON/OFF switch 6g correspond to the control mode switch for selecting the control mode. The timer switch 6b, the down switch 6e, and the up switch. 6f are setting switches for selecting a set value in each control mode. The timer switch 6b is a setting switch, and at the same time, is used as a control mode switch for transitioning to the timer mode. Thus, the setting switch and the control mode switch maybe made up of one switch.

FIG. 3 shows the front surface operation unit 8 and the front surface display unit 9 arranged on the front surface of the main body 1. The front surface operation unit 8 includes a selection switch 8a for switching between a first operation mode (hereinafter also referred to as “full mode”) enabling all functions of the cooking device, and a second operation mode (hereinafter also referred to as “simple mode”) for limiting the enabled functions. In the full mode, all control modes are set to be selectable, and all switches 6a to 6g of the top surface operation unit 6 are set to be enabled. In the simple mode, only the heating mode of the control modes is set to be selectable, and only the down switch 6e, the up switch 6f, and the heating ON/OFF switch 6g used in the heating mode are set to be enabled.

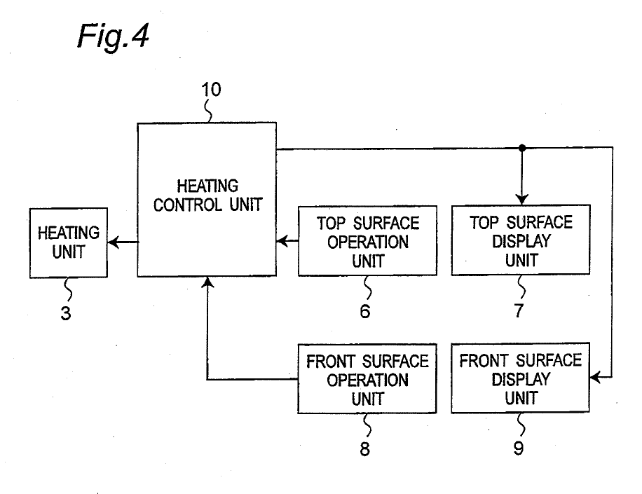

FIG. 4 is a block diagram showing a configuration of the cooking device of the present embodiment. The cooking device of the present embodiment includes a heating control unit 10 for controlling the heating unit 3 and switching the number of enabled control modes based on the operation of the selection switch 8a. The heating control unit 10 controls the heating unit 3 based on the switch operations of the top surface operation unit 6 and the front surface operation unit 8. The heating control unit 10 sets the control mode selectable by the top surface operation unit 6 according to the operation mode selected by the selection switch 8a. Further, the heating control unit 10 switches so that only the setting switch necessary for the execution of the relevant control mode can be operated, and displays the control mode switch and the setting switch usable at the top surface display unit 7 and switches to perform a display showing the operation mode currently selected at the front surface display unit 9.

In the present embodiment, when the selection switch 8a is continuously pushed for three or more seconds, the heating control unit 10 accepts the operation of the selection switch 8a, and switches from the full mode to the simple mode or from the simple mode to the full mode. When the switch other than the selection switch 8a in the top surface operation unit 6 and the front surface operation unit 8 is continuously pushed for one or more seconds, the heating control unit 10 accepts the operation of such a switch.

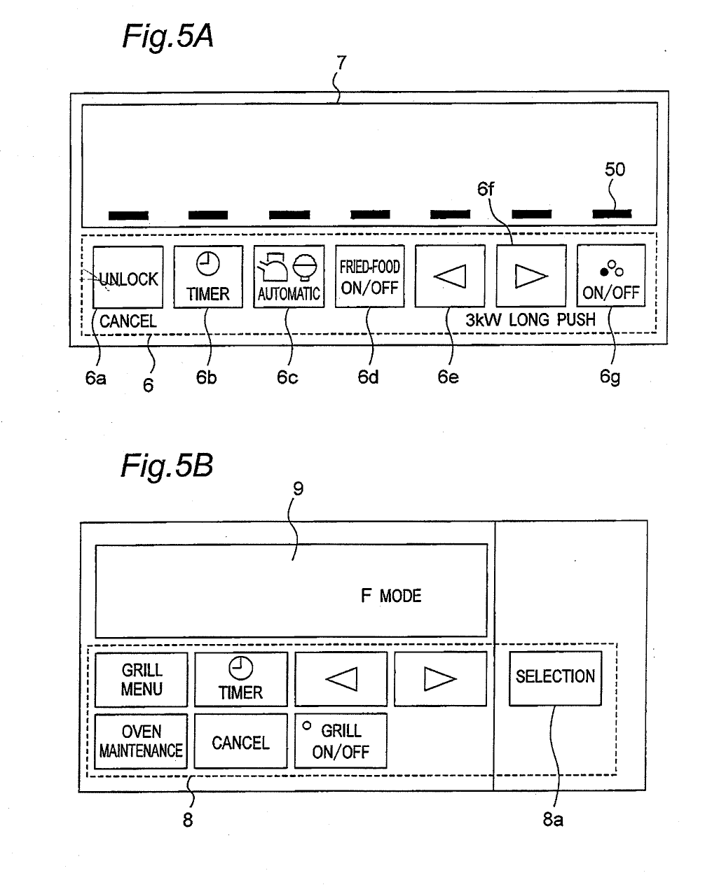

FIG. 5A. shows a state of the top surface operation unit 6 and the top surface display unit 7 when the power switch 15 is turned on, and FIG. 5B shows a state of the front surface operation unit 8 and the front surface display unit 9 when the power switch 15 is turned on. When the power switch 15 is turned on, the cooking device starts up in the full mode in which all control modes of the cooking device are selectable. In this case, the unlock mode, the timer mode, the automatic cooking mode, the fried-food mode, and the heating mode are all set to be selectable, and all switches 6a to 6g of the top surface display unit 7 are set to be enabled, an indication 50 by the light-emitting element is displayed at the upper part of all switches of the top surface display unit 7 to show that all switches 6a to 6g are usable, as shown in FIG. 5A. In this case, characters “F mode” indicating the full mode are displayed on the front surface display unit 9.

The operation of starting the heating of the cooking container 4 (operation of starting the heating mode) when the full mode is selected is carried out through a procedure of operating the unlock switch 6a (first procedure), and operating the heating ON/OFF switch 6g (second procedure). The unlock switch 6a is in a enabled state when the selection switch 8a of the front surface operation unit 8 is operated and the simple mode is not selected, and thus the heating control unit 10 controls the heating unit 3 to start heating when accepting the operation of the unlock switch 6a and then accepting the operation of the heating ON/OFF switch 6g.

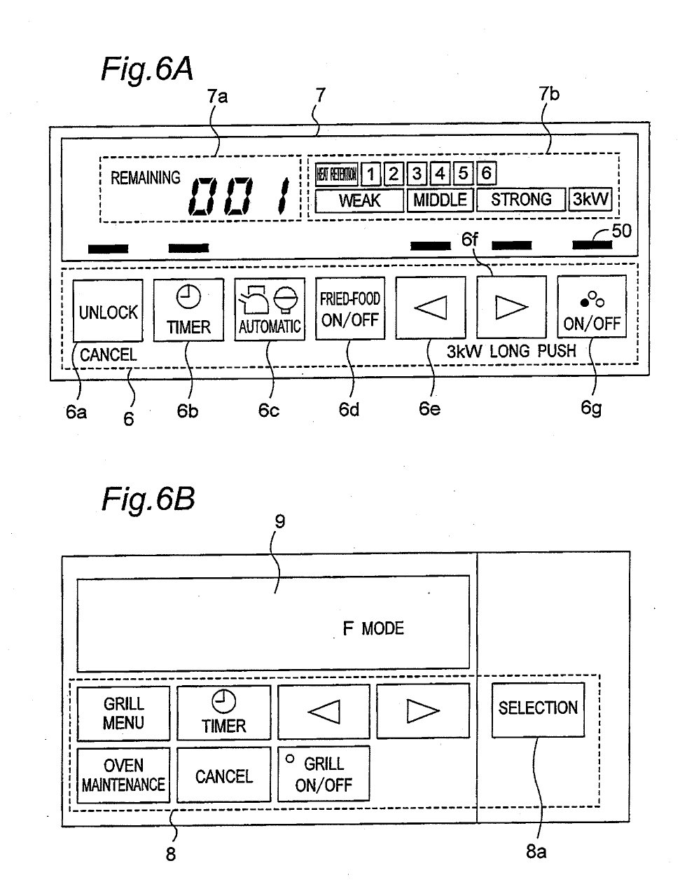

FIG. 6A shows a state of the top surface operation unit 6 and the top surface display unit 7 when the heating mode is selected and heating is being carried out in the full mode, and FIG. 6B shows a state of the front surface operation unit 8 and the front surface display unit 9 when the heating mode is selected and heating is being carried out in the full mode. During heating, a heating power set value 7b and a timer set time 7a are displayed in the top surface display unit 7. When the heating mode is selected and heating is being carried out in the full mode, a selecting function of the heating power set value by the operation of the down switch 6e (setting switch) and the up switch 6f (setting switch), a selecting function of the time set value of the cooking timer by the timer switch 6b (setting switch), and a stop function of heating by the heating ON/OFF switch 6g (control mode switch) are usable. The indication 50 by the light-emitting element is displayed in the top surface display unit 7 at the upper part of the usable switches 6a, 6b, 6e, 6f, and 6g. Even if the switches 6c and 6d without the indication 50 are operated, the control unit 10 does not accept the operation thereof. Therefore, in the full mode, the enabled control mode switch and the enabled setting switch, and the disabled control mode switch and the disabled setting switch are notified in a distinguished manner according to the selected control mode (heating mode in the case of FIG. 6).

When a switch without the indication 50 is operated for one or more seconds, the user is notified that the switch operated by the top surface display unit 7 is unusable. For example, when the disabled switch is operated, the top surface display unit 7 blinks the indication 50 corresponding to the operated switch for a predetermined period of time.

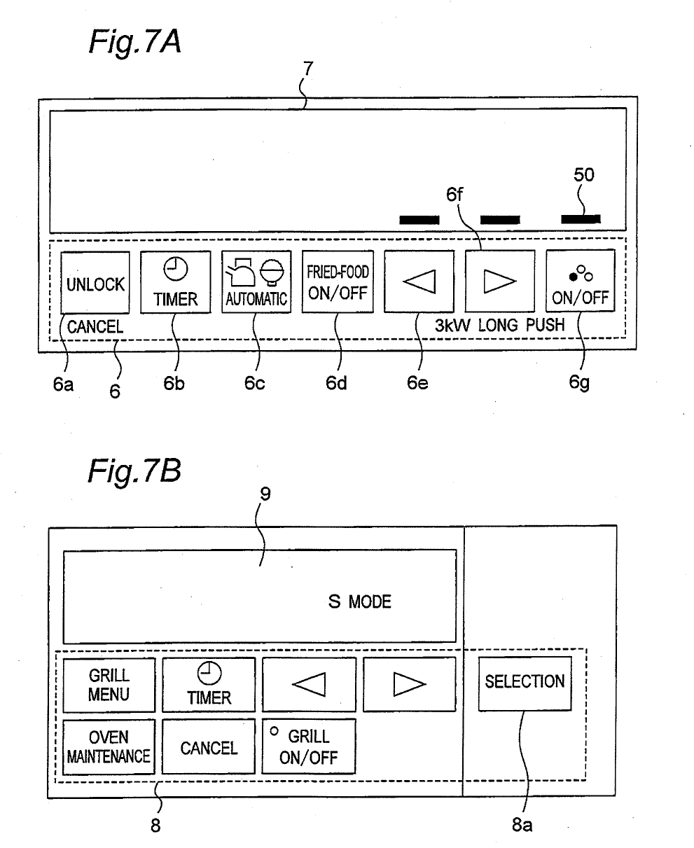

FIG. 7A shows a state of the top surface operation unit 6 and the top surface display unit 7 when switched to the simple mode after the power is turned on, and FIG. 7B shows a state of the front surface operation unit 8 and the front surface display unit 9 when switched to the simple mode after the power is turned on. When the selection switch 8a of the front surface operation unit 8 is operated after the power is turned on, the cooking device transitions from the full mode to the simple mode. In the simple mode, only the heating mode is selectable; only the down switch 6e, the up switch 6f, and the heating ON/OFF switch 6g used in the heating mode are enabled; and the indication 50 indicating that the switches are enabled is displayed by the light-emitting element over the switches 6e, 6f, 6g. This indicates that the switches 6a, 6b, 6c, 6d without the indication 50 cannot be operated. Therefore, in the simple mode as well, the enabled control mode switch and the enabled setting switch, and the disabled control mode switch and the disabled setting switch are notified in a distinguished manner. Furthermore, in the simple mode, characters “S mode” indicating the simple mode are displayed in the front surface display unit 9.

As shown in FIG. 7A, the down switch 6e, the up switch 6f, and the heating ON/OFF switch 6g, which operation is valid in the simple mode, are arranged adjacent to at least one switch, which operation is valid. The user can thus easily distinguish the usable control mode switch and the usable setting switch from the unusable control mode switch and the unusable setting switch.

The operation of starting heating of the cooking container 4 (operation of starting heating mode) in the simple mode is carried out only by operating the heating ON/OFF switch 6g (first procedure). In the simple mode, the heating control unit 15 sets the unlock switch 6a to be disabled, and thus the heating control unit 10 controls the heating unit 3 and starts heating immediately after accepting the operation of the heating ON/OFF switch 6g. In the simple mode, the unlock switch 6a is set to be disabled, and thus the heating control unit 10 does not accept the operation of the unlock switch 6a and the top surface display unit 7 does not change even if the operation of the unlock switch 6a is performed before the operation of the heating ON/OFF switch 6g.

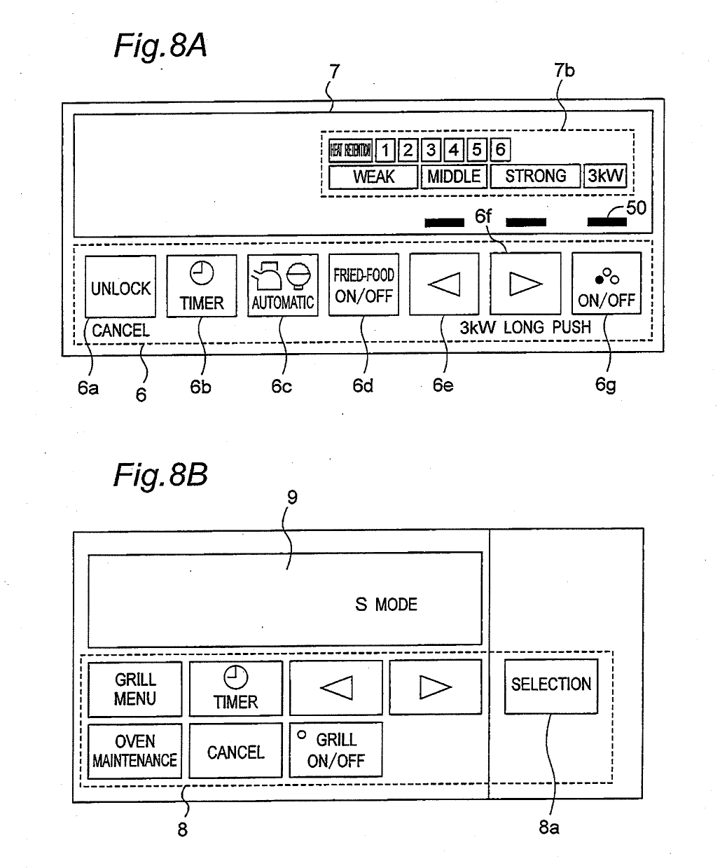

FIG. 8A shows a state of the top surface operation unit 6 and the top surface display unit 7 when the heating mode is selected and heating is being carried out in the simple mode, and FIG. 8B shows a state of the front surface operation unit 8 and the front surface display unit 9 when the heating mode is selected and heating is being carried out in the simple mode. In the simple mode, the heating power set value 7b is displayed in the top surface display unit 7 during heating. In the simple mode, the timer set time 7a shown in FIG. 6A is not displayed since the timer function cannot be used. During heating in the simple mode, the adjustment function of the heating power by the operation of the down switch 6e and the up switch 6f, and the stop function of heating by the heating ON/OFF switch 6g are usable. The indication 50 by the light-emitting element is displayed in the top surface display unit 7 over the usable switch. Even if the switch without the indication 50 is operated, the heating control unit 10 does not accept the operation thereof.

Therefore, in the present embodiment, the number of selectable control modes is changed and only the switches necessary for the selectable control mode are made enabled, by the operation of the selection switch 8a. Therefore, the operation procedure for starting heating also changes according to the selected operation mode.

As described above, a user who desires to use all the functions does not operate the selection switch 8a after turning on the power and performs the operation with the “F mode” displayed on the front surface display unit 9, so that heating can be performed in a state where a great number of functions can be used with a great number of switches that can be used.

A user who does not need to use all the functions and desires to perform heating with a simple operation operates the selection switch 8a and performs the operation with the “S mode” displayed on the front surface display unit 7, so that the number of switches that can be used is reduced, and heating and adjustment of the heating power can be carried out with a simpler operation.

Therefore, even if the device is the same, changes such as simplifying the operation procedure or quitting simplification and returning to the original mode can be easily carried out by changing the number of selectable control modes and having only the switches necessary for the relevant control mode enabled. Thus, a great number of functions can be provided to the user who can master complicating operations, whereas a simple operation procedure can be provided to the user who cannot perform complicating operations. An operating error of the user who cannot make sufficient use of the functions can be prevented, and a cooking device that is very easy to use for the user who requires only part of the functions of the cooking device is realized.

The correct operation can be induced by notifying the user with the top surface display unit 7 when the switch set to be disabled is operated.

Furthermore, since the usable switch is arranged to be adjacent to at least another usable switch in the simple mode, a plurality of enabled switches can be grouped, and the user can more easily distinguish the usable switch from the unusable switch. The operation is thus easier to perform.

Moreover, since the time (three seconds) required to accept the operation of the selection switch 8a is set longer than the time (one second) required to accept the operations of the switches 6a to 6g of the top surface operation unit 6, the operation of the selection switch 8a is hard to accept in comparison with the operations of the control mode switches 6a, 6c, 6d, 6g and the setting switches 6b, 6e, 6f. Therefore, the selection switch 8a is prevented from being carelessly operated. The selection switch 8a is thus prevented from being unconsciously operated by the user.

In the present embodiment, the time required for accepting the switch is set to one second and three seconds for the switches 6a to 6g of the top surface operation unit 6 and the selection switch 8a, respectively, but such time is not limited to the present embodiment. In addition, the number of operations required for accepting the switch may be arbitrarily set. For example, the function assigned to the switch may be executed when the switch is operated a plurality of times within a certain period of time. In this case, the number of operations (e.g., two times) required for accepting the selection switch 8a within the certain period of time is set greater than the number of operations (e.g., once) required for accepting the switches 6a to 6g of the top surface operation unit 6, so that the operation of the selection switch 8a is harder to accept than the operation of the control mode switches 6a, 6c, 6d, 6g and the setting switches 6b, 6e, 6f. When the selection switch 8a and the other switch are simultaneously operated, the other switch is accepted and the selection switch 8a is not accepted, so that the selection switch 8a is harder to accept than the other switch.

In the present embodiment, when the switch set to be disabled is operated, the top surface display unit 7 notifies the user that such switch cannot be operated, but the front surface display unit 9 may notify the user that the switch cannot be operated, instead of the top surface display unit 7.

The operation of the selection switch 8a may be performed at any time, or the operable timing thereof can be limited. For example, operation may be possible only within a predetermined time after the power is turned on.

In the present embodiment, the switching from the full mode to the simple mode and the switching from the simple mode to the full mode are enabled by the selection switch 8a, but only the switching from the full mode to the simple mode may be enabled by the operation of the selection switch 8a, and the mode may be returned to the full mode every time the power of the cooking device is turned on.

In the present embodiment, the cooking device has two operations modes, the full mode and the simple mode, but three or more operation modes may be provided. The enabled function may be set according to the respective operation modes.

### Second Embodiment

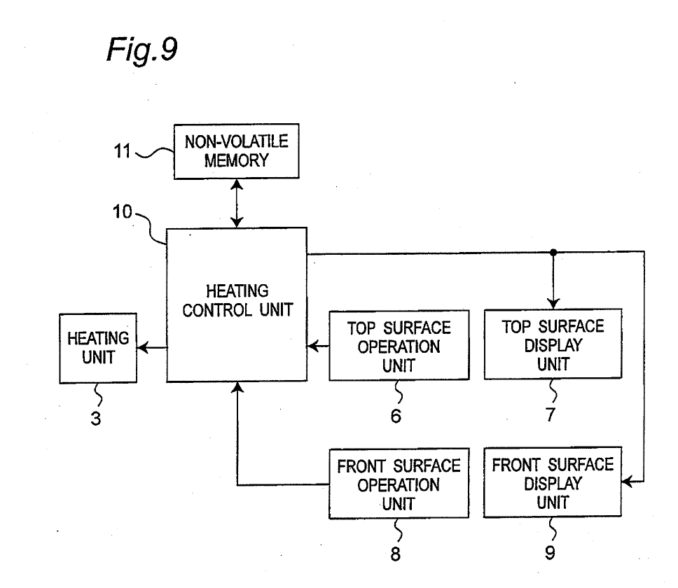

FIG. 9 shows a configuration of a cooking device of a second embodiment. The cooking device of the first embodiment is started up in the full mode when the power is turned on, but the cooking device of the second embodiment is started up in the stored operation mode (i.e., previously set operation mode).

The cooking device of the present embodiment further includes a non-volatile memory 11, which communicates with the heating control unit 10, in addition to the configuration of the first embodiment. The non-volatile memory 11 stores whether the cooking device is operating in the simple mode or is operating in the full mode.

In the present embodiment, the heating control unit 10 records, on the non-volatile memory 11, the operation state of the device (operation state indicating full mode or simple mode) when the main power of the cooking device is turned off by the user. When the main power of the cooking device is subsequently turned on, the heating control unit 10 reads the state of the device before the power switch 15 is turned off from the non-volatile memory 11. If the read state is the simple mode, for example, the indication 50 by the light-emitting element is displayed on the top surface display unit 7 over the down switch 6e, the up switch 6f, and the heating ON/OFF switch 6g to indicate that only the down switch 6e, the up switch 6f, and the heating ON/OFF switch 6g are usable, and to indicate that other switches cannot be operated, as shown in FIG. 7A. Furthermore, the “S mode” is displayed in the front surface display unit 9.

Therefore, in the present embodiment, the trouble of operating the selection switch 8a every time after the power is turned on can be saved since the operation mode before turning off the power is stored even if the power switch 15 of the cooking device is turned off.

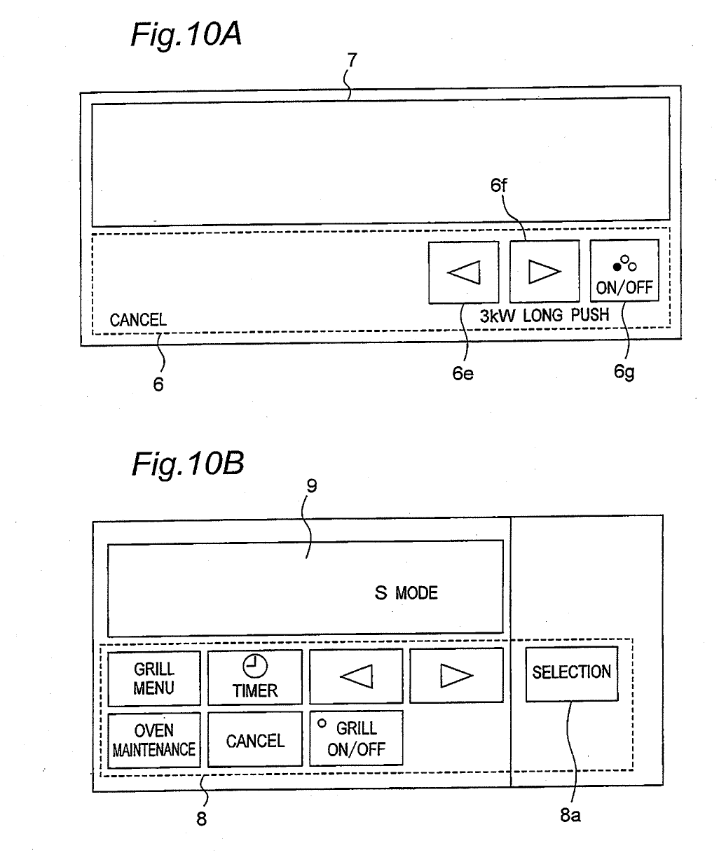

The enabled switches are indicated with the indication 50 in the first embodiment and the second embodiment, but the top surface operation unit 6 may have backlights corresponding to all of the plurality of switches 6a to 6g below each switch to notify only the enabled switches. A display example of the simple mode after the power is turned on in such a case is shown in FIGS. 10A and 10B. Only the switches 6e, 6f, 6g may be displayed by turning on the backlights arranged below the enabled switches 6e, 6f, 6g, and the switches 6a, 6b, 6c, 6d may not be displayed by turning off the backlights arranged below the disabled switches 6a, 6b, 6c, 6d. According to such a configuration, the user does not mistakenly operate the disabled switches.

In the first embodiment and the second embodiment, the automatic switch 6c, the fried-food OK/OFF switch 6d, and the heating ON/OFF switch 6g are individually arranged as control mode switches, but the configuration is not limited thereto. For example, a “menu switch” (not shown) may be arranged as the control mode switch, where the control mode to be selected may be changed in rotation every time the relevant switch is operated, and the heating ON/OFF switch may be operated after selecting the control mode to start heating. Therefore, two or more control mode switches may be operated to transit the control mode.

In the first embodiment and the second embodiment, the induction cooking device having the heating coil as the heating unit 3 has been described, but the present invention is not limited to this type of cooking device. A cooking device in which the heating unit is a radiant type, a halogen lamp type, or a gas type may also be adopted.

### INDUSTRIAL APPLICABILITY

The cooking device of the present invention has an effect in that a user who only uses basic functions can easily use the device having a great number of functions and a great number of switches, and is useful for a device having a great number of functions and a great number of switches, and the like.

1. A cooking device comprising:
a main body serving as shell;
a top plate provided on an upper surface of the main body;
a heating unit operable to heat an object to be heated placed on the upper surface of the main body;
at least one control mode switch operable to select one of a plurality of control modes for controlling a heating operation of the heating unit;
at least one setting switch operable to select a set value in each control mode;
a heating control unit operable to control the heating unit based on the control mode and the set value inputted through the control mode switch and the setting switch; and
a selection switch operable to select one operation mode from a plurality of operation modes; wherein
the operation modes include a first operation mode in which all of the plurality of control modes are set to be selectable and a second operation mode in which only part of the plurality of control modes are set to be selectable; and
the heating control unit sets only the control mode switch and the setting switch which are necessary for the control modes which are set to be selectable in the operation mode selected by the selection switch to be enabled.

2. The cooking device according to claim 1, further comprising a first notifying unit operable to notify distinctively the enabled control mode switch and the enabled setting switch from the disabled control mode switch and the disabled setting switch in the second operation mode

3. The cooking device according to claim 1, wherein the enabled control mode switch and the enabled setting switch are arranged adjacent to at least one other enabled control mode switch or enabled setting switch in the second operation mode.

4. The cooking device according to claim 2, further comprising a second notifying unit operable to notify whether the cooking device is operating in the first operation mode or in the second operation mode; wherein
when the disabled control mode switch or setting switch is operated, at least one of the first notifying unit or the second notifying unit notifies that the operated control mode switch or the operated setting switch is disabled.

5. The cooking device according to claim 1, wherein an operation of the selection switch is hard to be accepted compared to operations of the control mode switch and setting switch.

6. The cooking device according to claim 1, wherein
the selection switch is a switch which has an electrical contact and is operable to open or close; and
the control mode switch and the setting switch are touch switches of electrostatic capacity type.

7. The cooking device according to claim 1, further comprising:
a power switch operable to disable all operations in an OFF state of the power switch and to enable at least one switch to be operated in an ON state of the power switch; and
a non-volatile memory operable to store the operation mode selected by the selection switch when the power switch is in the ON state; wherein
the cooking device operates in the stored operation mode when the power switch is turned on.
